(19) United States
(12) Patent Application Publication
(10) Pub. No.: US 2025/0045626 A1
(43) Pub. Date: Feb. 6, 2025

(54) SERIALIZABLE SYNTHETIC DATA MODEL FOR DATA DRIFT DETECTION

(71) Applicant: Optum, Inc., Minnetonka, MN (US)

(72) Inventor: Jayanthi SURYANARAYANA, Eagan, MN (US)

(21) Appl. No.: 18/365,364

(22) Filed: Aug. 4, 2023

(51) Int. Cl. G06N 20/00

(52) U.S. Cl. CPC G06N 20/00

(57) ABSTRACT

Various embodiments of the present disclosure provide machine learning model performance monitoring techniques for automatically generating performance metrics for a machine learning model. The techniques may include identifying a generative synthetic data model corresponding to a historical training dataset for a target machine learning model, generating, using the generative synthetic data model, a synthetic dataset for the target machine learning model, generating a performance output for the target machine learning model based on a comparison between the synthetic dataset and a contemporary input dataset, and initiating the performance of one or more model performance-based operations based on the performance output for the target machine learning model.

### BACKGROUND

Various embodiments of the present disclosure address technical challenges related to the development, deployment, and management of machine learning models given limitations of existing model performance monitoring techniques, such as those for monitoring data drift between contemporary input data and the training data for a model. Traditionally, data drift detection techniques measure model failures based on direct statistical comparisons between contemporary data currently evaluated by a machine learning model and historical training datasets previously used to train the machine learning model. This requires machine learning systems to maintain both the code for executing the machine learning model and the robust dataset used to train, tune, and evaluate the model. Conventionally, both may be handled as a composite entity to ensure the reproducibility of the original training dataset to monitor for data drift. The storage or systematic retrieval of a training dataset corresponding to a deployed model presents numerous technical challenges due to data storage and governance requirements but is a necessary step in traditional robust data drift detection systems. Moreover, storing historical training datasets separately from a deployed model leads to increased data exposure risks and data governance complexities. Various embodiments of the present disclosure make important contributions to various existing machine learning performance monitoring techniques by addressing each of these technical challenges.

### BRIEF SUMMARY

Various embodiments of the present disclosure provide performance monitoring techniques for evaluating data drift for a machine learning model without a reliance on original training datasets. To do so, some embodiments of the present disclosure enable the replacement of historical training datasets with a generative synthetic data model. During one or more training operations for the machine learning model, a second model, a generative synthetic data model, may also be generated using the historical training dataset. The generative synthetic data model may be configured to generate a synthetic dataset, on demand, to simulate the historical training dataset at a time subsequent to the training of the machine learning model. By doing so, some embodiments of the present disclosure enable the replacement of robust training dataset with code configured to replicate the historical training dataset. In this way, robust, memory intensive datasets may be replaced with condensed representations of code that may be stored with a machine learning model in a composite model data object without consuming robust memory resources.

In some embodiments, a computer-implemented method includes identifying, by one or more processors, a generative synthetic data model corresponding to a historical training dataset for a target machine learning model; generating, by the one or more processors and using the generative synthetic data model, a synthetic dataset for the target machine learning model; generating, by the one or more processors, a performance output for the target machine learning model based on a comparison between the synthetic dataset and a contemporary input dataset; and initiating, by the one or more processors, the performance of one or more model performance-based operations based on the performance output for the target machine learning model.

In some embodiments, a computing system includes a memory and one or more processors communicatively coupled to the memory, the one or more processors are configured to identify a generative synthetic data model corresponding to a historical training dataset for a target machine learning model; generate, using the generative synthetic data model, a synthetic dataset for the target machine learning model; generate a performance output for the target machine learning model based on a comparison between the synthetic dataset and a contemporary input dataset; and initiate the performance of one or more model performance-based operations based on the performance output for the target machine learning model.

In some embodiments, one or more non-transitory computer-readable storage media include instructions that, when executed by one or more processors, cause the one or more processors to identify a generative synthetic data model corresponding to a historical training dataset for a target machine learning model; generate, using the generative synthetic data model, a synthetic dataset for the target machine learning model; generate a performance output for the target machine learning model based on a comparison between the synthetic dataset and a contemporary input dataset; and initiate the performance of one or more model performance-based operations based on the performance output for the target machine learning model.

### BRIEF DESCRIPTION OF DRAWINGS

FIG. 1 illustrates an example computing system in accordance with one or more embodiments of the present disclosure.

FIG. 2 is a schematic diagram showing a system computing architecture in accordance with some embodiments discussed herein.

FIG. 3 is a dataflow diagram showing example data structures for facilitating a performance monitoring technique in accordance with some embodiments discussed herein.

FIG. 4 is a dataflow diagram showing example data structures for generating a composite model data object in accordance with some embodiments discussed herein.

FIG. 5 is an operational example of an operational time period in accordance with some embodiments discussed herein.

FIG. 6 is a flowchart showing an example of a process for monitoring the performance of a machine learning model in accordance with some embodiments discussed herein.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that the present disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not necessarily indicate being based only on or based solely on the referenced element or elements unless so indicated. Like numbers refer to like elements throughout.

### I. COMPUTER PROGRAM PRODUCTS, METHODS, AND COMPUTING ENTITIES

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together, such as in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In some embodiments, a non-volatile computer-readable storage medium may include a floppy disk, flexible disk, hard disk, solid-state storage (SSS) (e.g., a solid-state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for, or used in addition to, the computer-readable storage media described above.

As should be appreciated, various embodiments of the present disclosure may also be implemented as methods, apparatuses, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. EXAMPLE FRAMEWORK

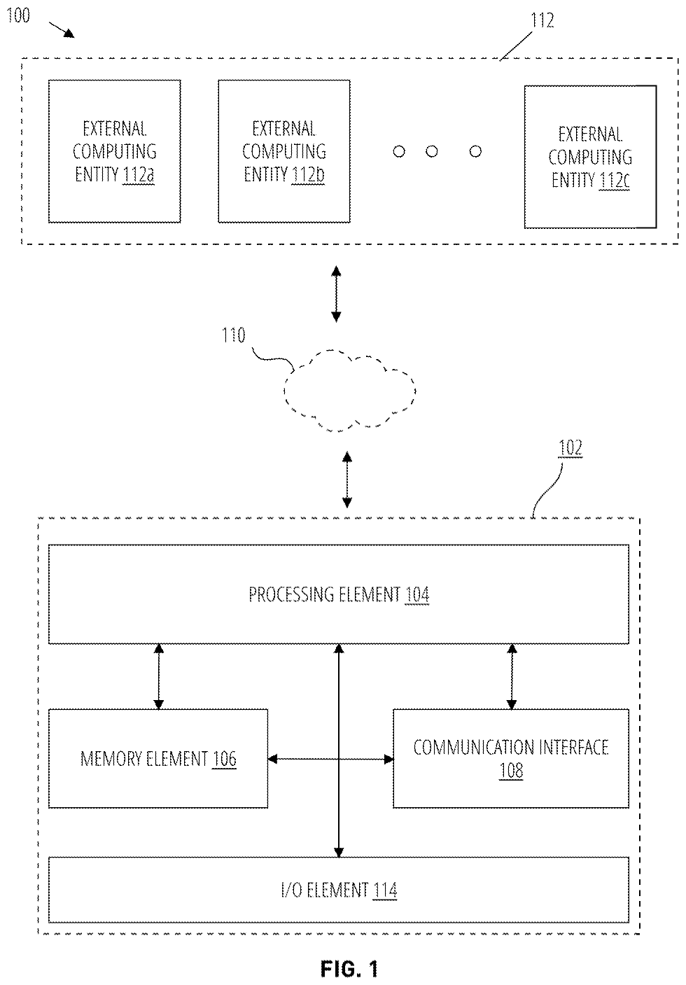

FIG. 1 illustrates an example computing system 100 in accordance with one or more embodiments of the present disclosure. The computing system 100 may include a predictive computing entity 102 and/or one or more external computing entities 112a-c communicatively coupled to the predictive computing entity 102 using one or more wired and/or wireless communication techniques. The predictive computing entity 102 may be specially configured to perform one or more steps/operations of one or more techniques described herein. In some embodiments, the predictive computing entity 102 may include and/or be in association with one or more mobile device(s), desktop computer(s), laptop(s), server(s), cloud computing platform(s), and/or the like. In some example embodiments, the predictive computing entity 102 may be configured to receive and/or transmit one or more datasets, objects, and/or the like from and/or to the external computing entities 112a-c to perform one or more steps/operations of one or more techniques (e.g., data lineage techniques, natural language processing techniques, data cataloging techniques, multi-stage data lineage mapping techniques, and/or the like) described herein.

The external computing entities 112a-c, for example, may include and/or be associated with one or more data sources configured to receive, store, manage, and/or facilitate model data, such as a model registry of a plurality of machine learning models, a historical and/or contemporary input data source, and/or the like. The external computing entities 112a-c, for example, may provide the access to the data to the predictive computing entity 102 through a plurality of different data sources and/or layers thereof. By way of example, the predictive computing entity 102 may include a performance monitoring platform that is configured to leverage data from the external computing entities 112a-c and/or one or more other data sources to monitor the performance of a machine learning model over an operational time period. In some examples, the operations of the predictive computing entity 102 may leverage composite model data objects, historical data, contemporary data, and/or the like provided by one or more of the external computing entities 112a-c to generate a target machine learning model, a generative synthetic data model, and/or a performance output for a target machine learning model, and/or the like. The external computing entities 112a-c, for example, may be associated with one or more data repositories, cloud platforms, compute nodes, organizations, and/or the like, that may be individually and/or collectively leveraged by the predictive computing entity 102 to generate and/or monitor the performance of a machine learning model.

The predictive computing entity 102 may include, or be in communication with, one or more processing elements 104 (also referred to as processors, processing circuitry, digital circuitry, and/or similar terms used herein interchangeably) that communicate with other elements within the predictive computing entity 102 via a bus, for example. As will be understood, the predictive computing entity 102 may be embodied in a number of different ways. The predictive computing entity 102 may be configured for a particular use or configured to execute instructions stored in volatile or non-volatile media or otherwise accessible to the processing element 104. As such, whether configured by hardware or computer program products, or by a combination thereof, the processing element 104 may be capable of performing steps or operations according to embodiments of the present disclosure when configured accordingly.

In one embodiment, the predictive computing entity 102 may further include, or be in communication with, one or more memory elements 106. The memory element 106 may be used to store at least portions of the databases, database instances, database management systems, data, applications, programs, program modules, scripts, source code, object code, byte code, compiled code, interpreted code, machine code, executable instructions, and/or the like being executed by, for example, the processing element 104. Thus, the databases, database instances, database management systems, data, applications, programs, program modules, scripts, source code, object code, byte code, compiled code, interpreted code, machine code, executable instructions, and/or the like, may be used to control certain aspects of the operation of the predictive computing entity 102 with the assistance of the processing element 104.

As indicated, in one embodiment, the predictive computing entity 102 may also include one or more communication interfaces 108 for communicating with various computing entities, e.g., external computing entities 112a-c, such as by communicating data, content, information, and/or similar terms used herein interchangeably that may be transmitted, received, operated on, processed, displayed, stored, and/or the like.

The computing system 100 may include one or more input/output (I/O) element(s) 114 for communicating with one or more users. An I/O element 114, for example, may include one or more user interfaces for providing and/or receiving information from one or more users of the computing system 100. The I/O element 114 may include one or more tactile interfaces (e.g., keypads, touch screens, etc.), one or more audio interfaces (e.g., microphones, speakers, etc.), visual interfaces (e.g., display devices, etc.), and/or the like. The I/O element 114 may be configured to receive user input through one or more of the user interfaces from a user of the computing system 100 and provide data to a user through the user interfaces.

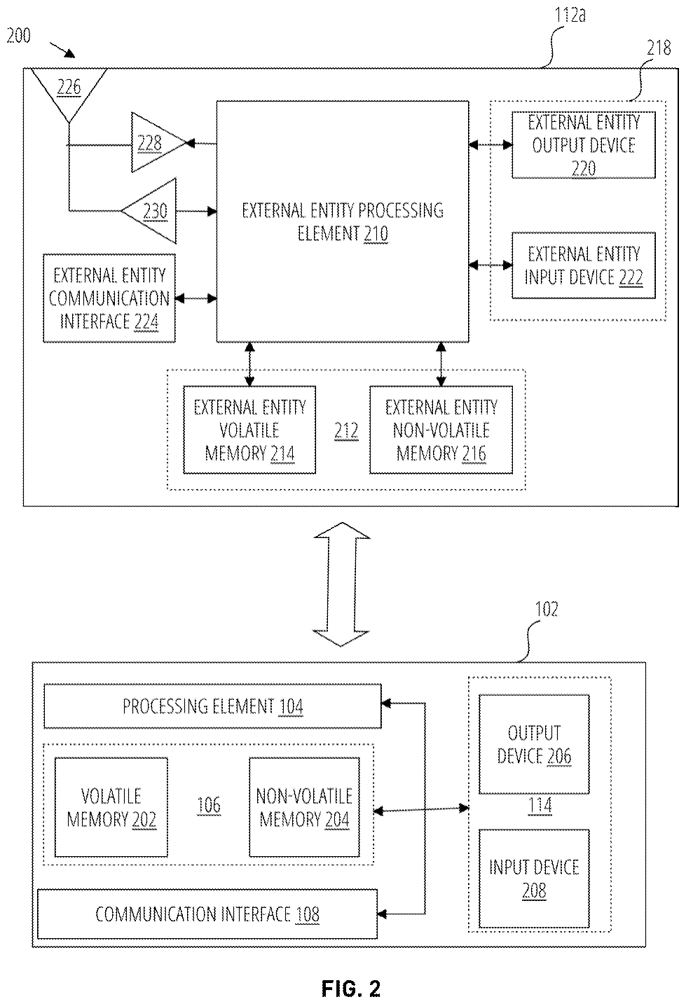

FIG. 2 is a schematic diagram showing a system computing architecture 200 in accordance with some embodiments discussed herein. In some embodiments, the system computing architecture 200 may include the predictive computing entity 102 and/or the external computing entity 112a of the computing system 100. The predictive computing entity 102 and/or the external computing entity 112a may include a computing apparatus, a computing device, and/or any form of computing entity configured to execute instructions stored on a computer-readable storage medium to perform certain steps or operations.

The predictive computing entity 102 may include a processing element 104, a memory element 106, a communication interface 108, and/or one or more I/O elements 114 that communicate within the predictive computing entity 102 via internal communication circuitry, such as a communication bus and/or the like.

The processing element 104 may be embodied as one or more complex programmable logic devices (CPLDs), microprocessors, multi-core processors, coprocessing entities, application-specific instruction-set processors (ASIPs), microcontrollers, and/or controllers. Further, the processing element 104 may be embodied as one or more other processing devices or circuitry including, for example, a processor, one or more processors, various processing devices, and/or the like. The term circuitry may refer to an entirely hardware embodiment or a combination of hardware and computer program products. Thus, the processing element 104 may be embodied as integrated circuits, application specific integrated circuits (ASICs), field programmable gate arrays (FPGAs), programmable logic arrays (PLAs), hardware accelerators, digital circuitry, and/or the like.

The memory element 106 may include volatile memory 202 and/or non-volatile memory 204. The memory element 106, for example, may include volatile memory 202 (also referred to as volatile storage media, memory storage, memory circuitry, and/or similar terms used herein interchangeably). In one embodiment, a volatile memory 202 may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for, or used in addition to, the computer-readable storage media described above.

The memory element 106 may include non-volatile memory 204 (also referred to as non-volatile storage, memory, memory storage, memory circuitry, and/or similar terms used herein interchangeably). In one embodiment, the non-volatile memory 204 may include one or more non-volatile storage or memory media, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

In one embodiment, a non-volatile memory 204 may include a floppy disk, flexible disk, hard disk, solid-state storage (SSS) (e.g., a solid-state drive (SSD)), solid state card (SSC), solid state module (SSM), enterprise flash drive, magnetic tape, or any other non-transitory magnetic medium, and/or the like. A non-volatile memory 204 may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile memory 204 may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

As will be recognized, the non-volatile memory 204 may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

The memory element 106 may include a non-transitory computer-readable storage medium for implementing one or more aspects of the present disclosure including as a computer-implemented method configured to perform one or more steps/operations described herein. For example, the non-transitory computer-readable storage medium may include instructions that when executed by a computer (e.g., processing element 104), cause the computer to perform one or more steps/operations of the present disclosure. For instance, the memory element 106 may store instructions that, when executed by the processing element 104, configure the predictive computing entity 102 to perform one or more step/operations described herein.

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language, such as an assembly language associated with a particular hardware framework and/or operating system platform. A software component comprising assembly language instructions may require conversion into executable machine code by an assembler prior to execution by the hardware framework and/or platform. Another example programming language may be a higher-level programming language that may be portable across multiple frameworks. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together, such as in a particular directory, folder, or library. Software components may be static (e.g., pre-established, or fixed) or dynamic (e.g., created or modified at the time of execution).

The predictive computing entity 102 may be embodied by a computer program product including non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media such as the volatile memory 202 and/or the non-volatile memory 204.

The predictive computing entity 102 may include one or more I/O elements 114. The I/O elements 114 may include one or more output devices 206 and/or one or more input devices 208 for providing and/or receiving information with a user, respectively. The output devices 206 may include one or more sensory output devices, such as one or more tactile output devices (e.g., vibration devices such as direct current motors, and/or the like), one or more visual output devices (e.g., liquid crystal displays, and/or the like), one or more audio output devices (e.g., speakers, and/or the like), and/or the like. The input devices 208 may include one or more sensory input devices, such as one or more tactile input devices (e.g., touch sensitive displays, push buttons, and/or the like), one or more audio input devices (e.g., microphones, and/or the like), and/or the like.

In addition, or alternatively, the predictive computing entity 102 may communicate, via a communication interface 108, with one or more external computing entities such as the external computing entity 112a. The communication interface 108 may be compatible with one or more wired and/or wireless communication protocols.

For example, such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In addition, or alternatively, the predictive computing entity 102 may be configured to communicate via wireless external communication using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.9 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

The external computing entity 112a may include an external entity processing element 210, an external entity memory element 212, an external entity communication interface 224, and/or one or more external entity I/O elements 218 that communicate within the external computing entity 112a via internal communication circuitry, such as a communication bus and/or the like.

The external entity processing element 210 may include one or more processing devices, processors, and/or any other device, circuitry, and/or the like described with reference to the processing element 104. The external entity memory element 212 may include one or more memory devices, media, and/or the like described with reference to the memory element 106. The external entity memory element 212, for example, may include one or more external entity volatile memory 214 and/or external entity non-volatile memory 216. The external entity communication interface 224 may include one or more wired and/or wireless communication interfaces as described with reference to communication interface 108.

In some embodiments, the external entity communication interface 224 may be supported by one or more radio circuitry. For instance, the external computing entity 112a may include an antenna 226, a transmitter 228 (e.g., radio), and/or a receiver 230 (e.g., radio).

Signals provided to and received from the transmitter 228 and the receiver 230, correspondingly, may include signaling information/data in accordance with air interface standards of applicable wireless systems. In this regard, the external computing entity 112a may be capable of operating with one or more air interface standards, communication protocols, modulation types, and access types. More particularly, the external computing entity 112a may operate in accordance with any of a number of wireless communication standards and protocols, such as those described above with regard to the predictive computing entity 102.

Via these communication standards and protocols, the external computing entity 112a may communicate with various other entities using means such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The external computing entity 112a may also download changes, add-ons, and updates, for instance, to its firmware, software (e.g., including executable instructions, applications, program modules), operating system, and/or the like.

According to one embodiment, the external computing entity 112a may include location determining embodiments, devices, modules, functionalities, and/or the like. For example, the external computing entity 112a may include outdoor positioning embodiments, such as a location module adapted to acquire, for example, latitude, longitude, altitude, geocode, course, direction, heading, speed, universal time (UTC), date, and/or various other information/data. In one embodiment, the location module may acquire data, such as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating a position of the external computing entity 112a in connection with a variety of other systems, including cellular towers, Wi-Fi access points, and/or the like. Similarly, the external computing entity 112a may include indoor positioning embodiments, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning embodiments may be used in a variety of settings to determine the location of someone or something to within inches or centimeters.

The external entity I/O elements 218 may include one or more external entity output devices 220 and/or one or more external entity input devices 222 that may include one or more sensory devices described herein with reference to the I/O elements 114. In some embodiments, the external entity I/O element 218 may include a user interface (e.g., a display, speaker, and/or the like) and/or a user input interface (e.g., keypad, touch screen, microphone, and/or the like) that may be coupled to the external entity processing element 210.

For example, the user interface may be a user application, browser, and/or similar words used herein interchangeably executing on and/or accessible via the external computing entity 112a to interact with and/or cause the display, announcement, and/or the like of information/data to a user. The user input interface may include any of a number of input devices or interfaces allowing the external computing entity 112a to receive data including, as examples, a keypad (hard or soft), a touch display, voice/speech interfaces, motion interfaces, and/or any other input device. In embodiments including a keypad, the keypad may include (or cause display of) the conventional numeric (0-9) and related keys (#, *, and/or the like), and other keys used for operating the external computing entity 112a and may include a full set of alphabetic keys or set of keys that may be activated to provide a full set of alphanumeric keys. In addition to providing input, the user input interface may be used, for example, to activate or deactivate certain functions, such as screen savers, sleep modes, and/or the like.

### III. EXAMPLES OF CERTAIN TERMS

In some embodiments, the term “target machine learning model” refers to a data entity that describes parameters, hyper-parameters, and/or defined operations of a machine learning model (e.g., model including at least one of one or more rule-based layers, one or more layers that depend on trained parameters, coefficients, and/or the like). A target machine learning model may include any type of model configured, trained, and/or the like to generate an output for a predictive and/or classification task in any predictive domain. A target machine learning model may include one or more of any type of machine learning model including one or more supervised, unsupervised, semi-supervised, reinforcement learning models, and/or the like. For instance, a target machine learning model may include a supervised model that may be trained using a historical training dataset. In some examples, a target machine learning model may include multiple models configured to perform one or more different stages of a classification and/or prediction process.

In some embodiments, a target machine learning model is designed and/or trained for a particular predictive domain associated with real world data that may be represented as a plurality of input data objects. A target machine learning model, for example, may be trained, using a historical training dataset, to generate a classification and/or prediction for an input data object based on one or more features of the input data object. In some examples, the performance of a target machine learning model may be based on a similarity between an input data object and a historical training dataset. In some examples, the performance of a target machine learning model may decrease over time due to data drift in which contemporary input data object features change with respect to a historical training dataset previously used to train the target machine learning model. In some embodiments, data drift detection processes are implemented to detect and accommodate for performance degradations due to data drift.

In some embodiments, the term “historical training dataset” refers to a data entity that describes training data for a target machine learning model. In some examples, training data may include supervised training data that includes a plurality of historical input data objects and/or a plurality of labels corresponding to the historical input data objects. As another example, training data may include unsupervised training data that includes one or more assumptions, rules, and/or the like that are representative of one or more features and/or expected outcomes for a plurality of historical input data objects. The historical input data objects may include a plurality of historical inputs that are used to train, validate, tune, and/or the like a target machine learning model at a historical time. In some examples, the historical time may correspond to a time preceding the deployment of a target machine learning model.

In some embodiments, a historical training dataset is based on real world data. For example, a historical training dataset may include a plurality of historical input data objects that represent one or more real world events, objects, and/or the like that occur during and/or within a temporal threshold (e.g., a month, year, etc.) of one or more training operations for a target machine learning model. By way of example, a historical training dataset may include an original training dataset for a target machine learning model that is used to initially train the target machine learning model. The original training dataset may be indicative of a plurality of input data objects that correspond to one or more time periods within a temporal threshold of one or more initial training operations for a target machine learning model. As another example, a historical training dataset may include a retraining dataset for a target machine learning model that is used to retrain the target machine learning model to account for and/or in anticipation of one or more performance degradations of the target machine learning model. The retraining dataset may be indicative of a plurality of input data objects that correspond to one or more time periods within a temporal threshold of one or more retraining operations for a target machine learning model. In some examples, a historical training dataset may correspond to a most recent dataset used to train, tune, and/or evaluate a target machine learning model.

In some embodiments, the term “contemporary input dataset” refers to a data entity that describes input data for a target machine learning model over a period of time. A contemporary input dataset may include a plurality of input data objects that correspond to a time period at least partially after a training and/or retraining operation for a target machine learning model. For example, a contemporary input dataset may include a plurality of input data objects that correspond to an evaluation time period. As described herein, an evaluation time period may include a period of time between at least two machine learning performance-based operations.

In some embodiments, the term “input data object” refers to a data entity that describes an input for a target machine learning model. An input data object may include any type of input based on the target machine learning model. In some examples, the input data object may include a plurality of features that describe one or more characteristics of the input data object. In some examples, a target machine learning model may be trained to generate a prediction, classification, and/or one or more other insights for the input data object based on the plurality of features of the input data object.

In some embodiments, the input data object is based on a predictive domain. For example, an input data object may include an image in an image processing domain, a unit of text in a text processing domain, a medical claim, patient, and/or the like for a clinical prediction domain, and/or the like.

In some embodiments, the term “generative synthetic data model” refers to a data entity that describes parameters, hyper-parameters, and/or defined operations of a statistical and/or machine learning model (e.g., model including at least one of one or more rule-based layers, one or more layers that depend on trained parameters, coefficients, and/or the like). A generative synthetic data model may include any type of model configured, trained, and/or the like to generate synthetic data representing another dataset. In some examples, a generative synthetic data model may include a statistical model, such as a linear regression model, tree-based model, and/or like, that is configured to generate synthetic data based on one or more statistical assumptions, probability distributions, and/or the like for a historical training dataset. In addition, or alternatively, a generative synthetic data model may include a machine learning model. A generative synthetic data model, for example, may include one or more of any type of machine learning model including one or more supervised, unsupervised, semi-supervised, reinforcement learning models, and/or the like. For instance, a generative synthetic data model may include a deep learning model, such as a neural network, convolution neural network, recurrent neural network, and/or the like that may be trained using a historical training dataset to generate a synthetic dataset representative of the historical training dataset. In this manner, a historical training dataset may be represented as a model that may be configured to generate a synthetic dataset representative of the historical training dataset at a future time.

In some embodiments, the term “evaluation sample” refers to a data entity that describes an output of the generative synthetic data model. The evaluation sample may include a portion of a synthetic dataset. The evaluation sample, for example, may include one or more synthetic data objects that correspond to (e.g., represent, etc.) one or more historical data objects from a historical training dataset. Each of the synthetic data objects may include one or more of the same and/or similar attributes, distributions, combinations, and/or the like relative to one or more historical data objects of a historical training dataset. A synthetic data object, for example, may include artificial data generated from real world data that is structurally and/or statistically like the historical training dataset.

In some embodiments, the term “synthetic dataset” refers to a synthetic data entity that describes historical training data for a target machine learning model. The synthetic dataset may include a plurality of evaluation samples generated by a generative synthetic data model. The synthetic dataset may correspond to (e.g., represent, etc.) a historical training dataset for the target machine learning model such that, if a query is run on a historical training dataset and the synthetic dataset, the results are comparable. In this way, a synthetic dataset may maintain a statistical similarity with the historical training dataset that may be later retrieved systematically for building robust data drift detection systems, and/or the like.

In some embodiments, the term “data model representation” refers to a data entity that represents a generative synthetic data model. A data model representation, for example, may include a serialized representation of a generative synthetic data model. The serialized representation may include an encoded data structure that may represent one or more weights, parameters, and/or attributes of a generative synthetic data model. The data model representation may be stored and then deserialized to generate a generative synthetic data model.

In some embodiments, the term “model registry” refers to a data structure for maintaining and/or providing access to one or more machine learning models. For instance, a model registry may include one or more database(s), for example local database(s), cloud database(s), and/or any combination thereof. The model registry may be specially configured to store any number of data object(s), each embodying a stored machine learning model. In some embodiments, for example, a respective model registry may be specially configured to store a composite model data object for each of a plurality of trained (and/or validated) machine learning models. By way of example, a respective model registry may include a plurality of model interface points for a plurality of models published to the model registry.

In some embodiments, the term “composite model data object” refers to a data object of a model registry. A composite model data object, for example, may include model data that is indicative of a machine learning model, such as one or more weights, parameters, features, a model architecture, a model location, and/or the like for configuring and/or executing a machine learning model. By way of example, model data may be indicative of a code set for executing a machine learning model. In some examples, the composite model data object may include data indicative of a training dataset for a machine learning model. For instance, a composite model data object may include data indicative of a historical training dataset. The data may include the historical training dataset, a pointer to the historical training dataset, and/or the like. In some examples, the composite model data object may include model data and a data model representation corresponding to the historical training dataset. In this manner, model and data may be managed in the same way within the same data structure. For instance, the training data may be managed as code that may be executed to generate a synthetic dataset that maintains a statistical similarity with a historical training dataset without requiring the storage of the historical training dataset.

The storage and/or systematic retrieval of a historical training dataset corresponding to a machine learning model presents a number of technical challenges for machine learning model maintenance. However, it is needed to facilitate robust data drift detection processes. By representing the historical training dataset as a data model representation, a historical training dataset may be reproduced using data small enough to fit within the same data structure as a corresponding machine learning model. In this way, a historical training dataset may be maintained with minimal processing and memory costs, while decreasing data exposure risk, data governance complexity, and data retrieval rates.

In some embodiments, the term “performance output” refers to a data entity that describes an evaluation metric for a machine learning model. A performance output, for example, may include any metric (and/or combination thereof) for evaluating the actual, historical, and/or predicted performance of a machine learning model. By way of example, a performance output may be indicative of a predicted data drift between a historical training dataset and a contemporary input dataset. A predicted data drift, for example, may be indicative of a similarity measure between a historical training dataset and/or a contemporary input dataset. The similarity measure, for example, may be indicative of a statistical similarity between one or more features of the historical training dataset and/or a contemporary input dataset.

In some embodiments, a predicted data drift is indicative of a predicted performance of a machine learning model. For instance, a predicted data drift that is indicative of a low rate of dissimilarities between the historical training dataset and the contemporary dataset may be predictive of a high performance (accuracy, etc.) of a machine learning model, whereas a predicted data drift indicative of high rate of dissimilarities between the historical training dataset and the contemporary dataset may be predictive of a low (e.g., inaccuracy, etc.) performance of a machine learning model.

In some embodiments, the term “data drift monitoring frequency” refers to a data entity that describes a rate at which at least one component of a machine learning model is evaluated. A data drift monitoring frequency, for example, may include a time interval between one or more performance outputs for a machine learning model. By way of example, a data drift monitoring frequency may be indicative of a time period at which a new performance metric is generated after a previous performance metric for the machine learning model. In some examples, a data drift monitoring frequency may define an evaluation time period between two performance metrics.

In some embodiments, the term “evaluation time period” refers to a period of time between an interval defined by a data drift monitoring frequency. An evaluation time period, for example, may include a predefined time interval between the generation of one or more performance metrics of a machine learning model. In some examples, an evaluation time period may be dynamically defined. For example, an evaluation time period may be based on one or more population trends, real world events, and/or the like that may be predictive of a data drift between a historical and contemporary dataset. In some examples, the generation of a performance metric may be triggered by one or more population trends, real world events, and/or the like. In such a case, an evaluation time period may be indicative of a time period between (i) the generation of a previous performance metric and (ii) a triggering event for a subsequent performance metric.

In some embodiments, the term “training time period” refers to a period of time during which a machine learning model is trained and/or retrained. A training time period, for example, may include an original training time period during which a machine learning model is initially trained (e.g., before deployment). In addition, or alternatively, a training time period may include a subsequent training time period during which a machine learning model is retrained (e.g., after deployment) to account for a detected data drift.

In some embodiments, the term “model performance-based operation” refers to a predictive action responsive to a performance output. A model performance-based operation, for example, may include initiating the performance of one or more alerts, messages, instructions, and/or the like in response to a performance output. By way of example, a model performance-based operation may include initiating the provisioning of an alert indicative of a presence or absence of data drift for a machine learning model. As another example, a model performance-based operation may include initiating one or more model retraining operations. By way of example, one or more model retraining operations may include retraining a machine learning model using a contemporary input dataset to accommodate for data drifts between contemporary and historical input datasets.

In some embodiments, the term “performance threshold” refers to a data entity that describes a criterion for a model performance-based operation. A performance threshold, for example, may be indicative of an acceptable data drift for a machine learning model. The performance threshold may be indicative of a threshold difference between a historical and contemporary input dataset for a machine learning model. The performance threshold may include a threshold similarity score (e.g., 50%, 70%, 90%, etc.). In some examples, one or more retraining operations may be automatically triggered in response to a performance metric exceeding (and/or failing to achieve) a performance threshold.

### IV. OVERVIEW, TECHNICAL IMPROVEMENTS, AND TECHNICAL ADVANTAGES

Embodiments of the present disclosure present machine learning and data monitoring techniques that improve performance monitoring for machine learning models. Traditionally, machine learning systems may fail after deployment due to data drift in which variations in contemporary data from the historical training dataset used to train the machine learning model degrade the performance of the machine learning model. Performance degradations due to data drift are conventionally addressed by directly comparing the historical training dataset used to train the machine learning model to contemporary data collected during a current operational time period. Such techniques necessarily rely on the maintenance and data governance of the historical training datasets which may be robust units of data that require significant computing resources, such as memory resources to store copies of the data and processing resources to ensure data governance policies and prevent modifications to the data. Some techniques of the present disclosure improve upon conventional data drift monitoring techniques by removing the reliance on the historical training dataset, thereby reducing the computing resources necessary for implementing a machine learning model performance monitoring scheme.

To do so, some embodiments of the present disclosure enable the generation of a proxy dataset similar to the training dataset previously used to build the machine learning model. The proxy dataset, or synthetic dataset, may be generated using synthetic data generation techniques without requiring the long-term storage and governance of historical data. For instance, the historical training dataset may be replaced with a generative synthetic data model capable of reproducing historical training data for the machine learning model on demand. The generative synthetic data model may be serializable, allowing a condensed representation of the model to be stored in the same composite model data object as its associated machine learning model. During a performance evaluation operation, the representation of the synthetic data model may be retrieved and used to generate the synthetic data model. The synthetic data model may then generate a synthetic dataset representing the historical training dataset. The synthetic dataset may be used, in place of the historical training dataset, to evaluate data drift between a contemporary dataset and the historical training dataset. In this way, robust training datasets that traditionally require extensive computing resources may be replaced with code that may be systematically retrieved and used as a proxy for the training datasets. This, in turn, enables the implementation of robust data drift detection processes, such as those described herein, with reduced memory expenditure and minimized data governance complexities.

Example inventive and technologically advantageous embodiments of the present disclosure include (i) new generative synthetic data models and composite model representations for comprehensively representing a machine learning model in a memory efficient manner; (ii) model performance evaluation techniques that replace historical training datasets with on demand synthetic datasets; (iii) model training operations that automatically retrain a model to accommodate for data drift abnormalities, among others.

### V. EXAMPLE SYSTEM OPERATIONS

As indicated, various embodiments of the present disclosure make important technical contributions to data lineage tracking techniques. In particular, systems and methods are disclosed herein that implement a multi-stage data lineage mapping technique configured to automatically generate a holistic task attribute map for a complex data ecosystem with multiple hierarchical layers of data sources. The multi-stage data lineage mapping technique provides technical improvements over traditional data lineage tracking techniques by leveraging natural language models to automatically generate the task attribute map over multiple stages specifically designed to sequentially generate and then augment source-target relationships between layers of the complex data ecosystem. In this way, the multi-stage data lineage mapping techniques enable more holistic, comprehensive, and accurate data catalogs at the expense of less computing resources relative to traditional data lineage tracking techniques.

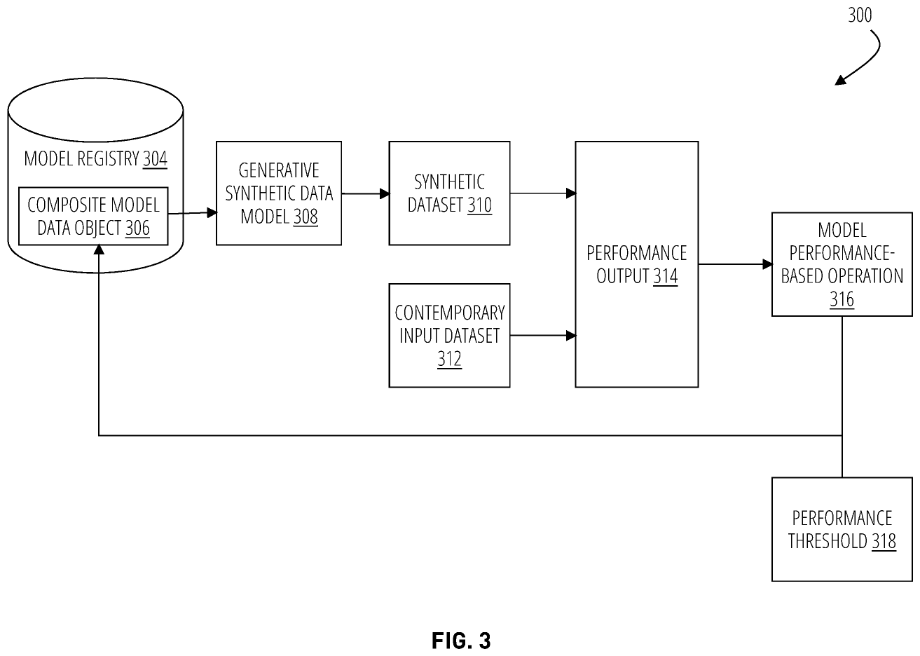

FIG. 3 is a dataflow diagram 300 showing example data structures for facilitating a performance monitoring technique in accordance with some embodiments discussed herein. The dataflow diagram 300 depicts a set of data structures and computing entities for generating a performance output 314 for a target machine learning model. The performance output 314 may be based on a comparison between a synthetic dataset 310 and a contemporary input dataset 312 associated with the target machine learning model.

In some embodiments, a generative synthetic data model 308 is identified for the target machine learning model. The generative synthetic data model 308 may correspond to a historical training dataset for the target machine learning model.

In some embodiments, the target machine learning model is a data entity that describes parameters, hyper-parameters, and/or defined operations of a machine learning model (e.g., model including at least one of one or more rule-based layers, one or more layers that depend on trained parameters, coefficients, and/or the like). A target machine learning model may include any type of model configured, trained, and/or the like to generate an output for a predictive and/or classification task in any predictive domain. A target machine learning model may include one or more of any type of machine learning model including one or more supervised, unsupervised, semi-supervised, reinforcement learning models, and/or the like. For instance, a target machine learning model may include a supervised model that may be trained using a historical training dataset. In some examples, a target machine learning model may include multiple models configured to perform one or more different stages of a classification and/or prediction process.

In some embodiments, a target machine learning model is designed and/or trained for a particular prediction domain associated with real world data that may be represented as a plurality of input data objects. A target machine learning model, for example, may be trained, using a historical training dataset, to generate a classification and/or prediction for an input data object based on one or more features of the input data object. In some examples, the performance of a target machine learning model may be based on a similarity between an input data object and a historical training dataset. In some examples, the performance of a target machine learning model may decrease over time due to data drift in which contemporary input data object features change with respect to a historical training dataset previously used to train the target machine learning model.

In some embodiments, the historical training dataset is a data entity that describes training data for the target machine learning model. In some examples, training data may include supervised training data that includes a plurality of historical input data objects and/or a plurality of labels corresponding to the historical input data objects. As another example, training data may include unsupervised training data that includes one or more assumptions, rules, and/or the like that are representative of one or more features and/or expected outcomes for a plurality of historical input data objects. The historical input data objects may include a plurality of historical inputs that are used to train, validate, tune, and/or the like the target machine learning model at a historical time. In some examples, the historical time may correspond to a time preceding the deployment of the target machine learning model.

In some embodiments, the historical training dataset is based on real world data. For example, the historical training dataset may include a plurality of historical input data objects that represent one or more real world events, objects, and/or the like that occur during and/or within a temporal threshold (e.g., a month, year, etc.) of one or more training operations for the target machine learning model. By way of example, the historical training dataset may include an original training dataset for the target machine learning model that is used to initially train the target machine learning model. The original training dataset may be indicative of a plurality of input data objects that correspond to one or more time periods within a temporal threshold of one or more initial training operations for the target machine learning model. As another example, the historical training dataset may include a retraining dataset for the target machine learning model that is used to retrain the target machine learning model to account for and/or in anticipation of one or more performance degradations of the target machine learning model. The retraining dataset may be indicative of a plurality of input data objects that correspond to one or more time periods within a temporal threshold of one or more retraining operations for a target machine learning model. In some examples, the historical training dataset may correspond to a most recent dataset used to train, tune, and/or evaluate the target machine learning model.

In some embodiments, the generative synthetic data model 308 is a data entity that describes parameters, hyper-parameters, and/or defined operations of a statistical and/or machine learning model (e.g., model including at least one of one or more rule-based layers, one or more layers that depend on trained parameters, coefficients, and/or the like). The generative synthetic data model 308 may include any type of model configured, trained, and/or the like to generate synthetic data representing another dataset. In some examples, the generative synthetic data model 308 may include a statistical model, such as a linear regression model, tree-based model, and/or like, that is configured to generate synthetic data based on one or more statistical assumptions, probability distributions, and/or the like for a historical training dataset. In addition, or alternatively, the generative synthetic data model 308 may include a machine learning model. The generative synthetic data model 308 may include one or more of any type of machine learning model including one or more supervised, unsupervised, semi-supervised, reinforcement learning models, and/or the like. For instance, the generative synthetic data model 308 may include a deep learning model, such as a neural network, convolution neural network, recurrent neural network, and/or the like that may be trained using a historical training dataset to generate a synthetic dataset 310 representative of the historical training dataset. In this manner, a historical training dataset may be represented as a model that may be configured to generate a synthetic dataset 310 representative of the historical training dataset at a future time.

In some embodiments, the generative synthetic data model 308 is identified based on a composite model data object 306 corresponding to the target machine learning model. For example, a data model representation indicative of the generative synthetic data model 308 may be stored within a model registry 304 in association with the target machine learning model. The model registry 304, for example, may include a plurality of composite model data objects. Each of the plurality of composite model data objects may include a respective target machine learning model and a respective data model representation indicative of a respective generative synthetic data model corresponding to the respective target machine learning model. In some examples, the data model representation may include a serialized representation of the generative synthetic data model 308.

In some embodiments, the model registry 304 is a data structure for maintaining and/or providing access to one or more machine learning models. For instance, the model registry 304 may include one or more database(s), for example local database(s), cloud database(s), and/or any combination thereof. The model registry 304 may be specially configured to store any number of data object(s), each embodying a stored machine learning model. In some embodiments, for example, the model registry 304 may be specially configured to store a composite model data object 306 for each of a plurality of trained (and/or validated) machine learning models. By way of example, the model registry 304 may include a plurality of model interface points for a plurality of models published to the model registry 304. Each interface point may provide access for executing a respective machine learning model stored in a respective composite model data object.

In some embodiments, the composite model data object 306 is a data object of a model registry 304. The composite model data object 306, for example, may include model data that is indicative of a machine learning model, such as one or more weights, parameters, features, a model architecture, a model location, and/or the like for configuring and/or executing a machine learning model. By way of example, model data may be indicative of a code set for executing the target machine learning model. In some examples, the composite model data object 306 may include data indicative of a training dataset for a machine learning model. For instance, a composite model data object 306 may include data indicative of a historical training dataset. The data may include the historical training dataset, a pointer to the historical training dataset, and/or the like. In some examples, the composite model data object 306 may include model data and/or a data model representation corresponding to the historical training dataset. In this manner, model and data information may be managed in the same way within the same data structure. For instance, the training data may be managed as code that may be executed to generate a synthetic dataset 310 that maintains a statistical similarity with a historical training dataset without requiring the storage of the historical training dataset.

As described herein, the storage and/or systematic retrieval of a historical training dataset corresponding to a machine learning model presents a number of technical challenges for the maintenance of machine learning models. However, it is needed to facilitate robust data drift detection processes. By representing the historical training dataset as a data model representation, a historical training dataset may be reproduced using data small enough to fit within the same data structure as a corresponding machine learning model. In this way, a historical training dataset may be maintained with minimal processing and memory costs, while decreasing data exposure risk, data governance complexity, and data retrieval rates.

In some embodiments, the data model representation is a data entity that represents a generative synthetic data model 308. The data model representation, for example, may include a serialized representation of the generative synthetic data model 308. The serialized representation may include an encoded data structure that may represent one or more weights, parameters, and/or attributes of the generative synthetic data model 308. The data model representation may be stored and then deserialized to generate the generative synthetic data model 308.

In some embodiments, a synthetic dataset 310 is generated for the target machine learning model using the generative synthetic data model 308. The generative synthetic data model 308, for example, may be generated by deserializing the data model representation corresponding to the generative synthetic data model 308. A plurality of evaluation samples corresponding to the historical training dataset may be generated using the generative synthetic data model 308. The plurality of evaluation samples may be aggregated to generate the synthetic dataset 310.

In some embodiments, an evaluation sample is a data entity that describes an output of the generative synthetic data model 308. The evaluation sample may include a portion of a synthetic dataset 310. The evaluation sample, for example, may include one or more synthetic data objects that correspond to (e.g., represent, etc.) one or more historical data objects from a historical training dataset. Each of the synthetic data objects may include one or more of the same and/or similar attributes, distributions, combinations, and/or the like relative to one or more historical data objects of a historical training dataset. A synthetic data object, for example, may include artificial data generated from real world data that is structurally and/or statistically like the historical training dataset.

In some embodiments, the synthetic dataset 310 is an artificial data entity that describes historical training data for a target machine learning model. The synthetic dataset 310 may include a plurality of evaluation samples generated by the generative synthetic data model 308. The synthetic dataset may correspond to (e.g., represent, etc.) a historical training dataset for the target machine learning model such that, if a query is run on a historical training dataset and the synthetic dataset, the results are comparable. In this way, the synthetic dataset 310 may maintain a statistical similarity with the historical training dataset that may be later retrieved systematically for building robust data drift detection systems, and/or the like.

In some embodiments, the performance output 314 is generated for the target machine learning model based on a comparison between the synthetic dataset 310 and a contemporary input dataset 312. In some examples, the performance output 314 may be indicative of a predicted data drift between a historical training dataset and the contemporary input dataset 312.

In some embodiments, the contemporary input dataset 312 is a data entity that describes input data for a target machine learning model over a period of time. The contemporary input dataset 312 may include a plurality of input data objects that correspond to a time period at least partially after a training and/or retraining operation for a target machine learning model. For example, the contemporary input dataset 312 may include a plurality of input data objects that correspond to an evaluation time period. As described herein, an evaluation time period may include a period of time between at least two machine learning model performance-based operations.

In some embodiments, an input data object is a data entity that describes an input for a target machine learning model. An input data object may include any type of input based on the target machine learning model. In some examples, the input data object may include a plurality of features that describe one or more characteristics of the input data object. In some examples, a target machine learning model may be trained to generate a prediction, classification, and/or one or more other insights for the input data object based on the plurality of features of the input data object.

In some embodiments, the input data object is based on a predictive domain. For example, an input data object may include an image in an image processing domain, a unit of text in a text processing domain, a medical claim, patient, and/or the like for a clinical prediction domain, and/or the like.

In some embodiments, the performance output 314 is a data entity that describes an evaluation metric for a machine learning model. The performance output 314, for example, may include any metric (and/or combination thereof) for evaluating the actual, historical, and/or predicted performance of a machine learning model. By way of example, the performance output may be indicative of a predicted data drift between a historical training dataset and a contemporary input dataset 312. A predicted data drift, for example, may be indicative of a similarity measure between a historical training dataset and/or the contemporary input dataset 312. The similarity measure, for example, may be indicative of a statistical similarity between one or more features of the historical training dataset and/or the contemporary input dataset 312.

In some embodiments, a predicted data drift is indicative of a predicted performance of a machine learning model. For instance, a predicted data drift that is indicative of a low rate of dissimilarities (e.g., 90% similarity score, etc.) between the historical training dataset and the contemporary input dataset 312 may be predictive of a high performance (accuracy, etc.) of a machine learning model, whereas a predicted data drift indicative of a high rate of dissimilarities (e.g., 40% similarity score, etc.) between the historical training dataset and the contemporary input dataset 312 may be predictive of a low performance (e.g., inaccuracy, etc.) of a machine learning model.

In some embodiments, the performance of one or more model performance-based operations 316 may be initiated based on the performance output 314 for the target machine learning model. The one or more model performance-based operations 316 may include one or more model retraining operations using the contemporary input dataset 312. In some examples, the one or more model performance-based operations 316 may be initiated based on a comparison between the performance output 314 and a performance threshold 318 for the target machine learning model.

In some embodiments, the model performance-based operation 316 may include a predictive action responsive to the performance output 314. The model performance-based operation 316, for example, may include initiating the performance of one or more alerts, messages, instructions, and/or the like in response to the performance output 314. By way of example, a model performance-based operation 316 may include initiating the provisioning of an alert indicative of a presence or absence of data drift for the target machine learning model. As another example, a model performance-based operation 316 may include initiating one or more model retraining operations. By way of example, one or more model retraining operations may include retraining a machine learning model using the contemporary input dataset 312 to accommodate for data drifts between contemporary and historical input datasets. In some examples, the one or more model retraining operations may be initiated in response to a performance metric exceeding (and/or failing to achieve) the performance threshold 318.

In some embodiments, the performance threshold 318 is a data entity that describes a criterion for a model performance-based operation 316. The performance threshold 318, for example, may be indicative of an acceptable data drift for a machine learning model. The performance threshold 318 may be indicative of a threshold dissimilarity (and/or similarity) between a historical and contemporary input dataset 312 for the target machine learning model. For example, the performance threshold 318 may include a threshold similarity score (e.g., 50%, 70%, 90%, etc.). In some examples, the one or more retraining operations may be automatically triggered in response to a performance metric failing to achieve (and/or exceeding) a performance threshold, such as the threshold similarity score.

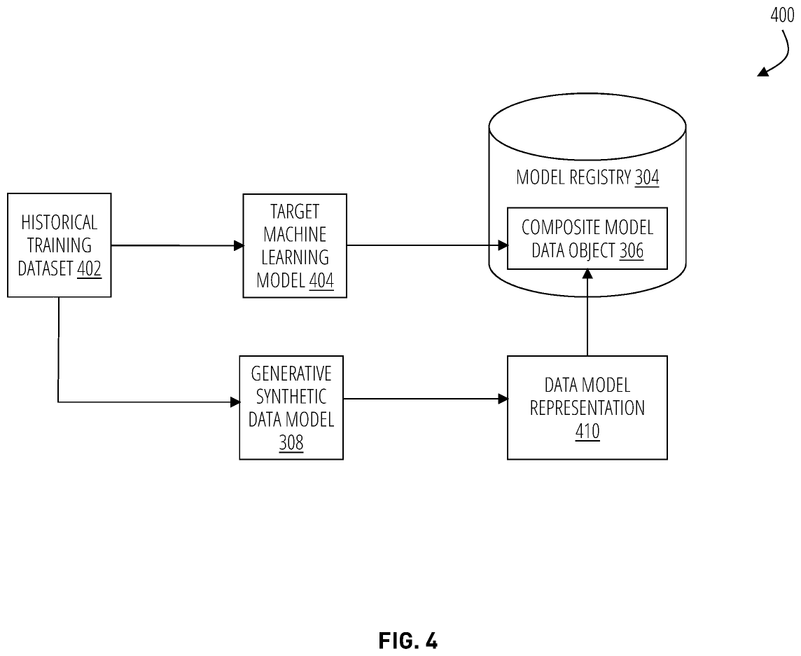

As described herein, the model performance-based operation 316 may be initiated based on a performance output 314 that is generated based on a synthetic dataset 310 as opposed to a historical training dataset. The synthetic dataset 310 is generated using a generative synthetic data model 308 configured for a particular historical training dataset. In some examples, the generative synthetic data model 308 may be previously generated for a historical training dataset to remove a target machine learning model's reliance on the historical training dataset. Thereafter, a representation of the generative synthetic data model 308 may be stored in a composite model data object 306, such that data drift (and/or other performance metrics) for a target machine learning model may be evaluated using a single data structure. An example of a process for generating the composite model data object 306 will now further be described with reference to FIG. 4.

FIG. 4 is a dataflow diagram 400 showing example data structures for generating a composite model data object in accordance with some embodiments discussed herein. The dataflow diagram 400 depicts a set of data structures and computing entities for generating a composite model data object 306 for a target machine learning model 404. The composite model data object 306 may include data indicative of the target machine learning model 404 and/or data indicative of a historical training dataset 402. In some examples, the historical training dataset 402 may be represented using a data model representation 410 of a generative synthetic data model 308 that is configured to generate synthetic data representative of the historical training dataset 402.

In some embodiments, the generative synthetic data model 308 is another machine learning model previously trained using the historical training dataset 402 to generate one or more synthetic datasets representing the historical training dataset 402. In some examples, the generative synthetic data model 308 is previously generated within a training time period corresponding to one or more training operations for the target machine learning model 404. For example, during a training time period, the target machine learning model 404 may be trained using the historical training dataset 402. At least partially during the same time period, the generative synthetic data model 308 may be separately trained using the same (and/or at least a portion of the same) historical training dataset 402.

In some embodiments, a data model representation 410 is generated for the generative synthetic data model 308, for example, by serializing the generative synthetic data model 308. In some embodiments, the composite model data object 306 is generated for the target machine learning model 404 based on the data model representation 410. For example, the composite model data object 306 may include a representation of the target machine learning model 404 and the data model representation 410 for the generative synthetic data model 308.

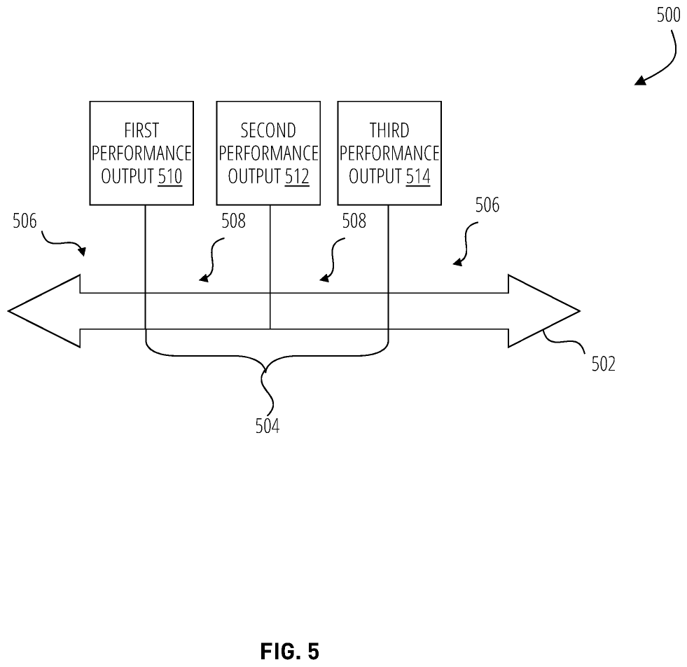

As described herein, the composite model data object 306 may be leveraged to generate performance outputs for the target machine learning model 404. In some examples, the composite model data object 306 may be leveraged in a model performance monitoring scheme for monitoring the performance of a deployed machine learning model. In some examples, the model performance monitoring scheme may include generating a respective performance output 314 for the target machine learning model 404 at a data drift monitoring frequency. An example data drift monitoring frequency will now further be described with reference to FIG. 5.

FIG. 5 is an operational example of an operational time period 502 in accordance with some embodiments discussed herein. The operational time period 502 includes one or more training time periods 506 and evaluation time periods 508 for a target machine learning model. During an operational time period 502, the target machine learning model may be evaluated at a data drift monitoring frequency 504.

In some embodiments, the data drift monitoring frequency 504 describes a rate at which at least one component of a machine learning model is evaluated. The data drift monitoring frequency 504, for example, may include a time interval between one or more performance outputs for a machine learning model. By way of example, the data drift monitoring frequency 504 may be indicative of a time period at which a new performance metric is generated after a previous performance metric for the machine learning model. In some examples, the data drift monitoring frequency 504 may define an evaluation time period 508 between two performance metrics.

In some embodiments, an evaluation time period 508 is a period of time between an interval defined by the data drift monitoring frequency 504. The evaluation time period 508, for example, may include a predefined time interval between the generation of one or more performance metrics of a machine learning model. In some examples, an evaluation time period may be dynamically defined. For example, the evaluation time period 508 may be based on one or more population trends, real world events, and/or the like that may be predictive of a data drift between a historical and/or contemporary dataset. In some examples, the generation of a performance metric may be triggered by one or more population trends, real world events, and/or the like. In such a case, the evaluation time period 508 may be indicative of a time period between (i) the generation of a previous performance metric and (ii) a triggering event for a subsequent performance metric.

In some embodiments, the training time period 506 refers to a period of time during which a machine learning model is trained and/or retrained. A training time period, for example, may include an original training time period during which a machine learning model is initially trained (e.g., before deployment). In addition, or alternatively, a training time period may include a subsequent training time period during which a machine learning model is retrained (e.g., after deployment) to account for a detected data drift.

In some embodiments, the data drift monitoring frequency 504 is indicative of evaluation time periods 508 between two performance outputs generated for a target machine learning model. For example, a first evaluation time period may include a period of time between a first performance output 510 and a second performance output 512, a second evaluation time period may include a period of time between the second performance output 512 and a third performance output 514, and/or the like. In some examples, a contemporary input dataset for the target machine learning model may include a plurality of input data objects corresponding to an evaluation time period. For example, a second performance output 512 may be generated using a contemporary input dataset including input data objects corresponding to an evaluation time period between the first performance output 510 and the second performance output 512.

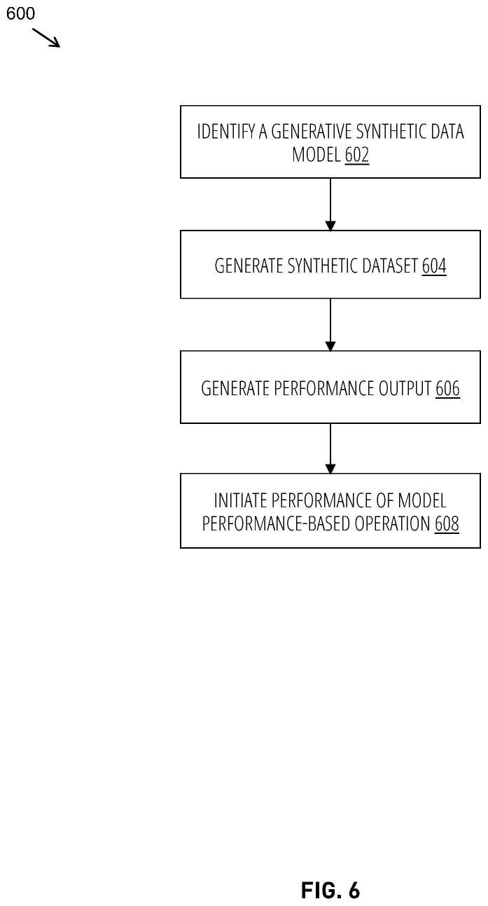

FIG. 6 is a flowchart showing an example of a process 600 for monitoring the performance of a machine learning model in accordance with some embodiments discussed herein. The flowchart depicts new performance monitoring technique for evaluating a machine learning model that overcomes various limitations of traditional performance monitoring techniques that rely on the maintenance and data governance of historical training datasets. The performance monitoring techniques may be implemented by one or more computing devices, entities, and/or systems described herein. For example, via the various steps/operations of the process 600, the computing system 100 may leverage the performance monitoring techniques to overcome the various limitations with traditional performance monitoring techniques by facilitating a performance evaluation of a model using synthetic data generated by a generative synthetic data model. In this manner, historical training datasets may be replaced with code that is easier to maintain, store, and retrieve.

FIG. 6 illustrates an example process 600 for explanatory purposes. Although the example processes 600 depicts a particular sequence of steps/operations, the sequence may be altered without departing from the scope of the present disclosure. For example, some of the steps/operations depicted may be performed in parallel or in a different sequence that does not materially impact the function of the process 600. In other examples, different components of an example device or system that implements the process 600 may perform functions substantially at the same time or in a specific sequence.

In some embodiments, the process 600 includes, at step/operation 602, identifying a generative synthetic data model. For example, the computing system 100 may identify the generative synthetic data model corresponding to a historical training dataset for a first machine learning model. The first machine learning model, for example, may be a target machine learning model for which one or more performance monitoring techniques are performed. For example, a data model representation indicative of the generative synthetic data model may be stored within a model registry in association with the first machine learning model. The model registry may include a plurality of composite model data objects. Each of the plurality of composite model data objects may include a respective machine learning model and a respective data model representation indicative of a respective generative synthetic data model corresponding to the respective machine learning model. The data model representation may include a serialized representation of the generative synthetic data model. In some examples, the generative synthetic data model may be identified from the plurality of composite model data objects based on the data model representation.

In some embodiments, the generative synthetic data model is a second machine learning model, different from the first machine learning model, that is previously trained using the historical training dataset to generate one or more synthetic datasets representing the historical training dataset. The generative synthetic data model, for example, may be previously generated within a training time period corresponding to one or more training operations for the first machine learning model. By way of example, during one or more training operations, two individual machine learning models may be generated, in parallel, using a historical training dataset. A first may include a first machine learning model, such as the target machine learning model described herein. A second may include a second machine learning model, such as the generative synthetic machine learning model.

In some embodiments, the process 600 includes, at step/operation 604, generating a synthetic dataset. For example, the computing system 100 may generate, using the generative synthetic data model, the synthetic dataset for the first machine learning model. In some examples, computing system 100 may generate the generative synthetic data model by deserializing a data model representation corresponding to the generative synthetic data model. In some examples, the computing system 100 may generate, using the generative synthetic data model, a plurality of evaluation samples corresponding to the historical training dataset. The synthetic dataset may include the plurality of evaluation samples. As described herein, by replacing a historical training dataset with a synthetic dataset that may be generated on demand using a generative synthetic data model, some techniques of the present disclosure may improve performance monitoring techniques by reducing computing resources, such as storage requirements, needed to monitor model performance over time.

In some embodiments, the process 600 includes, at step/operation 606, generate a performance output. For example, the computing system 100 may generate the performance output for the first machine learning model based on a comparison between the synthetic dataset and a contemporary input dataset. In some examples, the performance output may be indicative of a predicted data drift between the historical training dataset and the contemporary input dataset. In some examples, a respective performance output is generated for the first machine learning model at a data drift monitoring frequency. For instance, the data drift monitoring frequency may be indicative of an evaluation time period and the contemporary input dataset may include a plurality of input data objects corresponding to the evaluation time period.

In some embodiments, the process 600 includes, at step/operation 608, initiate performance of model performance-based operation. For example, the computing system 100 may initiate the performance of one or more model performance-based operations based on the performance output for the first machine learning model. In some examples, the one or more model performance-based operations may include one or more model retraining operations using the contemporary input dataset. In some examples, the one or more model performance-based operations may be initiated based on a comparison between the performance output and a performance threshold for the first machine learning model.

Some techniques of the present disclosure enable the generation of action outputs that may be performed to initiate one or more actions to achieve real-world effects. The performance monitoring techniques of the present disclosure may be used, applied, and/or otherwise leveraged to machine learning performance outputs These outputs may be leveraged to initiate the performance of various computing tasks that improve the performance of a machine learning models (e.g., a computer itself, etc.) with respect to various actions performed by the computing system 100.

In some examples, the computing tasks may include actions that may be based on the setting in which the performance monitoring techniques are used. For instance, the performance monitoring techniques may be used in any environment in which computing systems may be applied to achieve real-word insights and initiate the performance of computing tasks, such as actions (e.g., alerts, etc.), to act on the real-world insights. These actions may cause real-world changes, for example, by controlling a hardware component (e.g., to disable a device executing a target machine learning model, etc.), providing condition alerts (e.g., to flag a target machine learning model, etc.), and/or the like.

Example settings may include financial systems, clinical systems, autonomous systems, robotic systems, and/or the like. Actions in such settings may include the initiation of automated instructions across and between devices, automated notifications, automated maintenance scheduling operations, automated precautionary actions, automated security actions, and/or the like.

In some embodiments, the performance monitoring techniques are applied to initiate the performance of one or more actions. An action may depend on the setting. In some examples, the computing system 100 may leverage the performance monitoring techniques to monitor the performance of a deployed machine learning model. A performance output may be leveraged to automatically monitor and control the use and/or accessibility of the target machine learning model over an operational time period. Moreover, the performance output may be displayed as a visual rendering to illustrate a model performance metrics in real time.

### VI. CONCLUSION

Many modifications and other embodiments will come to mind to one skilled in the art to which the present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

### VII. EXAMPLES

Example 1. A computer-implemented method, the computer-implemented method comprising identifying, by one or more processors, a generative synthetic data model corresponding to a historical training dataset for a machine learning model; generating, by the one or more processors and using the generative synthetic data model, a synthetic dataset for the machine learning model; generating, by the one or more processors, a performance output for the machine learning model based on a comparison between the synthetic dataset and a contemporary input dataset; and initiating, by the one or more processors, the performance of one or more model performance-based operations based on the performance output for the machine learning model.

Example 2. The computer-implemented method of example 1, wherein a data model representation indicative of the generative synthetic data model is stored within a model registry in association with the machine learning model.

Example 3. The computer-implemented method of example 2, wherein the model registry comprises a plurality of composite model data objects and each of the plurality of composite model data objects comprises a respective machine learning model and a respective data model representation indicative of a respective generative synthetic data model corresponding to the respective machine learning model.

Example 4. The computer-implemented method of examples 2 or 3, wherein the data model representation comprises a serialized representation of the generative synthetic data model.

Example 5. The computer-implemented method of example 4, wherein generating the synthetic dataset comprises generating the generative synthetic data model by deserializing the data model representation; and generating, using the generative synthetic data model, a plurality of evaluation samples corresponding to the historical training dataset.

Example 6. The computer-implemented method of any of the preceding examples, wherein the generative synthetic data model comprises another machine learning model previously trained using the historical training dataset to generate one or more synthetic datasets representing the historical training dataset.

Example 7. The computer-implemented method of any of the preceding examples, wherein the generative synthetic data model is previously generated within a training time period corresponding to one or more training operations for the machine learning model.

Example 8. The computer-implemented method of any of the preceding examples, wherein the performance output is indicative of a predicted data drift between the historical training dataset and the contemporary input dataset.

Example 9. The computer-implemented method of any of the preceding examples, wherein a respective performance output is generated for the machine learning model at a data drift monitoring frequency.

Example 10. The computer-implemented method of example 9, wherein the data drift monitoring frequency is indicative of an evaluation time period and the contemporary input dataset comprises a plurality of input data objects corresponding to the evaluation time period.

Example 11. The computer-implemented method of any of the preceding examples, wherein the one or more model performance-based operations comprise one or more model retraining operations using the contemporary input dataset.

Example 12. The computer-implemented method of any of the preceding examples, wherein the one or more model performance-based operations are initiated based on a comparison between the performance output and a performance threshold for the machine learning model.

Example 13. A computing system comprising memory and one or more processors communicatively coupled to the memory, the one or more processors configured to identify a generative synthetic data model corresponding to a historical training dataset for a machine learning model; generate, using the generative synthetic data model, a synthetic dataset for the machine learning model; generate a performance output for the machine learning model based on a comparison between the synthetic dataset and a contemporary input dataset; and initiate the performance of one or more model performance-based operations based on the performance output for the machine learning model.

Example 14. The computing system of example 13, wherein a data model representation indicative of the generative synthetic data model is stored within a model registry in association with the machine learning model.

Example 15. The computing system of example 14, wherein the model registry comprises a plurality of composite model data objects and each of the plurality of composite model data objects comprises a respective machine learning model and a respective data model representation indicative of a respective generative synthetic data model corresponding to the respective machine learning model.

Example 16. The computing system of examples 14 or 15, wherein the data model representation comprises a serialized representation of the generative synthetic data model.

Example 17. The computing system of example 16, wherein generating the synthetic dataset comprises generating the generative synthetic data model by deserializing the data model representation; and generating, using the generative synthetic data model, a plurality of evaluation samples corresponding to the historical training dataset.

Example 18. One or more non-transitory computer-readable storage media including instructions that, when executed by one or more processors, cause the one or more processors to identify a generative synthetic data model corresponding to a historical training dataset for a machine learning model; generate, using the generative synthetic data model, a synthetic dataset for the machine learning model; generate a performance output for the machine learning model based on a comparison between the synthetic dataset and a contemporary input dataset; and initiate the performance of one or more model performance-based operations based on the performance output for the machine learning model.

Example 19. The one or more non-transitory computer-readable storage media of example 18, wherein the generative synthetic data model comprises another machine learning model previously trained using the historical training dataset to generate one or more synthetic datasets representing the historical training dataset.

Example 20. The one or more non-transitory computer-readable storage media of example 18 or 19, wherein the generative synthetic data model is previously generated within a training time period corresponding to one or more training operations for the machine learning model.

1. A computer-implemented method, the computer-implemented method comprising:
identifying, by one or more processors, a generative synthetic data model corresponding to a historical training dataset for a machine learning model;
generating, by the one or more processors and using the generative synthetic data model, a synthetic dataset for the machine learning model;
generating, by the one or more processors, a performance output for the machine learning model based on a comparison between the synthetic dataset and a contemporary input dataset; and
initiating, by the one or more processors, the performance of one or more model performance-based operations based on the performance output for the machine learning model.

2. The computer-implemented method of claim 1, wherein a data model representation indicative of the generative synthetic data model is stored within a model registry in association with the machine learning model.

3. The computer-implemented method of claim 2, wherein the model registry comprises a plurality of composite model data objects and each of the plurality of composite model data objects comprises a respective machine learning model and a respective data model representation indicative of a respective generative synthetic data model corresponding to the respective machine learning model.

4. The computer-implemented method of claim 2, wherein the data model representation comprises a serialized representation of the generative synthetic data model.

5. The computer-implemented method of claim 4, wherein generating the synthetic dataset comprises:
generating the generative synthetic data model by deserializing the data model representation; and
generating, using the generative synthetic data model, a plurality of evaluation samples corresponding to the historical training dataset.

6. The computer-implemented method of claim 1, wherein the generative synthetic data model comprises another machine learning model previously trained using the historical training dataset to generate one or more synthetic datasets representing the historical training dataset.

7. The computer-implemented method of claim 1, wherein the generative synthetic data model is previously generated within a training time period corresponding to one or more training operations for the machine learning model.

8. The computer-implemented method of claim 1, wherein the performance output is indicative of a predicted data drift between the historical training dataset and the contemporary input dataset.

9. The computer-implemented method of claim 1, wherein a respective performance output is generated for the machine learning model at a data drift monitoring frequency.

10. The computer-implemented method of claim 9, wherein the data drift monitoring frequency is indicative of an evaluation time period and the contemporary input dataset comprises a plurality of input data objects corresponding to the evaluation time period.

11. The computer-implemented method of claim 1, wherein the one or more model performance-based operations comprise one or more model retraining operations using the contemporary input dataset.

12. The computer-implemented method of claim 1, wherein the one or more model performance-based operations are initiated based on a comparison between the performance output and a performance threshold for the machine learning model.

13. A computing system comprising memory and one or more processors communicatively coupled to the memory, the one or more processors configured to:
identify a generative synthetic data model corresponding to a historical training dataset for a machine learning model;
generate, using the generative synthetic data model, a synthetic dataset for the machine learning model;
generate a performance output for the machine learning model based on a comparison between the synthetic dataset and a contemporary input dataset; and
initiate the performance of one or more model performance-based operations based on the performance output for the machine learning model.

14. The computing system of claim 13, wherein a data model representation indicative of the generative synthetic data model is stored within a model registry in association with the machine learning model.

15. The computing system of claim 14, wherein the model registry comprises a plurality of composite model data objects and each of the plurality of composite model data objects comprises a respective machine learning model and a respective data model representation indicative of a respective generative synthetic data model corresponding to the respective machine learning model.

16. The computing system of claim 14, wherein the data model representation comprises a serialized representation of the generative synthetic data model.

17. The computing system of claim 16, wherein generating the synthetic dataset comprises:
generating the generative synthetic data model by deserializing the data model representation; and
generating, using the generative synthetic data model, a plurality of evaluation samples corresponding to the historical training dataset.

18. One or more non-transitory computer-readable storage media including instructions that, when executed by one or more processors, cause the one or more processors to:
identify a generative synthetic data model corresponding to a historical training dataset for a machine learning model;
generate, using the generative synthetic data model, a synthetic dataset for the machine learning model;
generate a performance output for the machine learning model based on a comparison between the synthetic dataset and a contemporary input dataset; and
initiate the performance of one or more model performance-based operations based on the performance output for the machine learning model.

19. The one or more non-transitory computer-readable storage media of claim 18, wherein the generative synthetic data model comprises another machine learning model previously trained using the historical training dataset to generate one or more synthetic datasets representing the historical training dataset.

20. The one or more non-transitory computer-readable storage media of claim 18, wherein the generative synthetic data model is previously generated within a training time period corresponding to one or more training operations for the machine learning model.
